(19) United States
(12) Patent Application Publication
(10) Pub. No.: US 2023/0324720 A1
(43) Pub. Date: Oct. 12, 2023

(54) COLOUR FILTER FOR MODIFYING HUMAN COLOUR VISION AND METHOD OF DESIGNING SUCH A COLOUR FILTER

(71) Applicant: MEDICONTUR KFT., Zsámbék (HU)

(72) Inventors: György István ÁBRAHÁM, Budapest (HU); Róbert Tamás FEKETE, Budapest (HU); László KONTUR, Budapest (HU); Benjamin KONTUR, Budapest (HU); Péter KONCSÁR, Budapest (HU)

(73) Assignee: MEDICONTUR KFT., Zsámbék (HU)

(21) Appl. No.: 18/210,005

(22) Filed: Jun. 14, 2023

Related U.S. Application Data
(63) Continuation-in-part of application No. PCT/HU2021/050072, filed on Dec. 15, 2021.

(30) Foreign Application Priority Data
Dec. 16, 2020 (HU) P2000435

(51) Int. Cl. G02C 7/10

(52) U.S. Cl. CPC G02C 7/108; G02C 7/104

(57) ABSTRACT

Present invention relates to a colour filter (10) for modifying human colour vision, having a spectral transmission function in the visible light range wherein the average transmission in a wavelength range of at least 20 nm width below 530 nm is at least twice the average transmission in a second wavelength range between 530 and 580 nm, and the average transmission in a wavelength range of at least 20 nm width above 580 nm is at least twice the average transmission in the second wavelength range. The invention comprises a dyed carrier layer (12) and an interference layer (14) arranged thereon, the transmission function of the dyed carrier layer (12) and the transmission function of the colour filter (10) have the following relationship within the second wavelength range:

T_{sd}(λ)<1−V(λ)·(1−T(λ))·n
wherein
T(λ): is the transmission function of the colour filter (10),
T_{sd}(λ): is the transmission function of the dyed carrier layer (12),
V(λ): is the sensitivity function of the human eye normalized to 1,
n≥0.4.

The invention also relates to a method of designing such a colour filter (10).

### CROSS-REFERENCE TO RELATED APPLICATIONS

This application is a continuation-in-part of PCT/HU2021/050072, filed Dec. 15, 2021, claiming priority of Hungarian Patent Application No. P2000435, filed Dec. 16, 2020, both incorporated herein by reference.

### FIELD OF INVENTION

The object of the invention relates to a colour filter for modifying human colour vision, and method of producing such colour filter.

### BACKGROUND OF INVENTION

Some of the receptors located in the retina, the cones providing daylight vision, are categorised in three classes depending on their spectral sensitivity. The L-cones are mainly sensitive to the long wavelength (red) part of the spectrum. The M-cones are sensitive to the medium wavelength (green) part of the spectrum and the S-cones to the short wavelength (blue) part of the spectrum. The sense of colour is produced from the relative values of the stimuli transmitted by the L, M and S colour-sensing receptors compared to each other.

Colour vision deficiency is caused by the spectral sensitivity curves deviating from those of people with normal colour vision to smaller or greater extents, accordingly, the most frequent forms of colour blindness are protanomaly, protanopia, deuteranomaly and deuteranopia.

In case of protanomaly, the colour perception problem is caused by the spectral sensitivity of the L-cones being located closer to the spectral sensitivity of the M-cones than in the case of those with normal colour vision. As a consequence of this, due to the effect of a given external stimulus, the difference between the stimuli of the L-cones and M-cones is reduced, and this results in a deterioration of the ability to discriminate between colours. In extreme cases, the spectral sensitivity of the L-cones is shifted so much that it coincides with the sensitivity curve of the M-cones—this is called protanomaly.

In case of deuteranomaly the spectral sensitivity of the M-cones is located closer to the spectral sensitivity of the L-cones than in the case of those with normal colour vision. The result is similar to the previous case: the difference between the stimuli of the L-cones and the M-cones is reduced, i.e. in this case also there is a deterioration in the ability to discriminate colours. Deuteranomaly is when the sensitivity curve of the M-cones is shifted so much that it coincides with the sensitivity curve of the L-cones.

Even now colour vision deficiency is viewed as an incurable disorder as it has a genetic cause, in other words the sensitivity functions of the receptors cannot be changed. However, efforts are being made that are not aimed at improving the sensitivity functions of the receptors, instead they are aimed at attempting to modify the spectrum of the incoming light in order to improve colour vision despite shifted receptor sensitivities.

A solution is proposed in U.S. Pat. No. 5,774,202, according to which the effective or virtual sensitivity of the receptor may be spectrally shifted in the appropriate direction by using a suitably designed colour filter.

There are existing colour filter design methods that can be used to design the spectral transmission function of a colour filter for certain types of colour vision deficiencies, or even individually, to correct colour vision, and to manufacture the appropriate colour filter. It is noted that a colour filter may not only serve to correct the colour vision of people with colour vision deficiency, but may also be required to modify the colour vision of those with normal colour vision. For example, when using certain dashboards or control panels, it may be important to be able to recognise the colours of LED lights or other LED displays on them. The same objective may also apply, for example, to the colours of signals used in rail, air and waterborne transport. The need to better distinguish colours and at the same time maintain colour identification also arises in the case of displays used for entertainment purposes to ensure a better visual experience.

Patent application PCT/HU2020/050043 discloses a design method for designing a colour vision modifying colour filter for different purposes for people with colour vision deficiencies and people with normal colour vision. The result of such and similar design methods is usually a spectral transmission function that specifies the extent to which the filter to be produced should transmit visible light as a function of wavelength.

In the manufacture of colour filters for use as spectacles, the transmittance of a carrier layer is modified to match the spectral transmission function obtained by the design method. Typically, the starting point is a carrier layer with a constant spectral transmission function, i.e. not dependent on wavelength, and typically close to 1, i.e. a colourless transparent carrier layer. This constant transmission (typically 1) must be reduced in accordance with the designed transmission curve to produce, for example, the desired passbands and stopbands. There are generally two types of technology for this.

One known technology is to paint the carrier layer that forms the basis of the colour filter with a dye that has absorption properties and absorbs light in the wavelength range(s) where it is desired to modify colour vision.

The other known technology involves the creation of an optical thin layer system on the surface of the carrier layer that ensures, by interference, that the spectral transmission of the carrier layer is reduced as much as necessary in the desired wavelength ranges. The desired interference is provided by alternating thin layers of materials with smaller and larger refractive indices of different thicknesses on top of each other.

However, both technologies have their drawbacks.

The spectral transmission function of colour filters designed to correct for colour deficiency or to meet other special needs is usually a complex, e.g., a multi-band function comprising several passbands and stopbands. Dyes, on the other hand, are natural or synthetic materials the absorption properties of which are essentially determined by their chemical composition, so this cannot be tailored to the desired transmission properties. Most dyes have a broad absorption band, making them inherently unsuitable for use as a stopband in a narrow wavelength range. In the context of the present invention, a broad absorption band dye is defined as a dye having a full-width at half maximum (FWHM) greater than 40 nm around its absorption peak, preferably greater than 50 nm, more preferably greater than 60 nm. Although there are narrow absorption band dyes with an FWHM of 40 nm or less around the absorption peak, however their use is equally limited, since the narrow absorption band characteristic of the dye cannot be shifted along the wavelength, thus, even the combination of dyes may not provide the desired stopband in an arbitrary wavelength range.

Due to the mentioned limitations of the dyeing technology, colour filters with multi-band spectral transmission functions are produced using thin-layer technology. Due to the alternation of thin layers with low and high refractive indices, reflections occur at the layer boundaries and therefore such interference layers are reflective to a greater or lesser extent. The problem is aggravated when implementing complex spectral transmission functions with many steep steps, since accurate tracing of such spectral transmission functions may require the deposition of a large number of thin layers, up to 40-100, which causes a large number of layer boundaries and thus significant reflection. This reflection is undesirable in spectacles intended for normal wear, as it impairs or completely eliminates the possibility of eye contact. Numerous studies have shown that eye contact plays a major role in human contact. Eye contact is particularly important for building trust, so people with colour deficiency who are forced to wear highly reflective spectacles may be at a disadvantage in both professional and private life. Reflection can also occur on the other side of the spectacles, causing the user to see a blurred reflection of his or her own eyes, which is a ghostly, vision-disturbing phenomenon.

Although attempts have been made to combine the two technologies, there have been no significant benefits so far. The transmission curves of broad absorption band dyes show broad, U-shaped regions of little steepness. Starting with such a transmission curve in the thin-layer design process, it is still equally difficult to create the complex transmission curve comprising many steep steps that is obtained by the design process, and the creation of such a complex transmission curve still requires a large number of thin layers. In this case, the original problem remains, while dyeing necessarily complicates the manufacturing process. Narrow absorption band dyes are usually used if the desired transmission function happens to have an absorption band in the same narrow wavelength band, but this is not true in most cases. In addition, if the narrow absorption band of the dye falls within a wide stopband, the shape of the desired transmission function, which is modified by the dye, is rendered even more complex by adding one or two sharp steps depending on the location of the dye's absorption band, which is also undesirable.

US 2016/0077361 discloses a colour filtering lens wherein an interference filter is provided with an absorption layer having a peak absorption at approximately the same wavelength range where the transmission of the interference filter is lowest. However, this document teaches to keep the transmission of the interference filter as low as possible, preferably even as low as 2%, which results in substantial back reflection in spite of the applied absorption layer.

It is an object of the invention to provide a colour filter for modifying colour vision that is free from the drawbacks of prior art solutions. In particular, it is an object of the invention to provide a colour filter for reducing distracting reflection in the case where the colour filter has a complex, typically multi-band transmission function for special needs.

It is a further object of the invention to provide a manufacturing method for producing such colour filters.

### SUMMARY OF INVENTION

The inventors of the present invention have recognized that, notwithstanding the above problems, in the case of colour filters designed to correct colour vision deficiency, there is an unexpected advantage in pre-dyeing the carrier layer with a dye or combination of dyes of appropriate properties. The inventors have recognised that reflection is particularly disturbing at wavelengths where the value of the V-lambda function, i.e. the CIE photopic luminous efficiency function, which determines the light sensitivity of the human eye adapted to daylight, is high. The V-lambda function is roughly bell-shaped, ranging from 0 to 1, and peaks at about 555 nm. The V-lambda function is shown in FIG. 1.

The inventors recognized that if the spectral transmission function of a colour filter obtained by a colour filter design method is low in the vicinity of the maximum of the V-lambda function, i.e. a stopband is located there, blocking should be at least partially achieved by using absorption dyes instead of interference thin layers. Absorption dyes reduce the transmission by absorbing light, whereas interference layers reduce the transmission in significant part by way of reflection. For this reason, to achieve a reduction in transmission required by the designed transmission function, it is preferable to use a dye at least in the vicinity of the maximum of the V-lambda function, so that the interference layer can have a higher transmittance, i.e. less reflection, in this wavelength range. The inventors have also recognised that, since reflection is more disturbing the closer the wavelength of the reflected light is to 555 nm, it is desirable to use a dye that is increasingly involved in the desired reduction of the transmission the closer the wavelength is to 555 nm.

In view of the above findings, the object of the invention is achieved by a colour filter according to claim 1 and colour filter spectacles according to claim 16.

The invention further relates to a method according to claim 19 for designing such a colour filter.

Preferred embodiments of the invention are defined in the dependent claims.

### BRIEF DESCRIPTION OF DRAWINGS

Further details of the invention will now be described with reference to the accompanying drawings.

FIG. 1 is a graph of the V-lambda function of the human eye.

FIG. 2a is a schematic diagram of the structure of an exemplary colour filter according to the invention.

FIG. 2b is a schematic diagram of the structure of another exemplary colour filter according to the invention.

FIG. 2c is a schematic diagram of the structure of an exemplary colour filter according to the present invention comprising a clip-on lens.

FIG. 2d is a schematic diagram of the structure of an exemplary colour filter according to the invention comprising another clip-on lens.

FIG. 3a is a graph showing simultaneously the spectral transmission function of an exemplary colour filter according to the present invention, the spectral transmission function of the dyed carrier layer used in the colour filter, the V-lambda function, and a boundary function according to the present invention.

FIG. 3b is a graph showing simultaneously the spectral transmission target function used to produce the colour filter of FIG. 3a, the spectral transmission function of the dyed carrier layer used in the colour filter, the V-lambda function, the boundary function according to the present invention, and the spectral transmission of the target interference filter.

FIG. 4a is a graph showing simultaneously the spectral transmission function of another exemplary colour filter according to the present invention, the spectral transmission function of the dyed carrier layer used in the colour filter, the V-lambda function, and the boundary function according to the present invention.

FIG. 4b is a graph showing simultaneously the spectral transmission target function used to produce the colour filter of FIG. 4a, the spectral transmission function of the dyed carrier layer used in the colour filter, the V-lambda function, the boundary function according to the present invention, and the spectral transmission of the target interference filter.

FIG. 5 is a graph showing the transmission functions of dyed carrier layers containing the same type of dye at different concentrations.

FIG. 6 is a schematic flow diagram of an exemplary embodiment of a manufacturing method according to the invention.

FIG. 7 shows transmission curves of exemplary commercially available dyes.

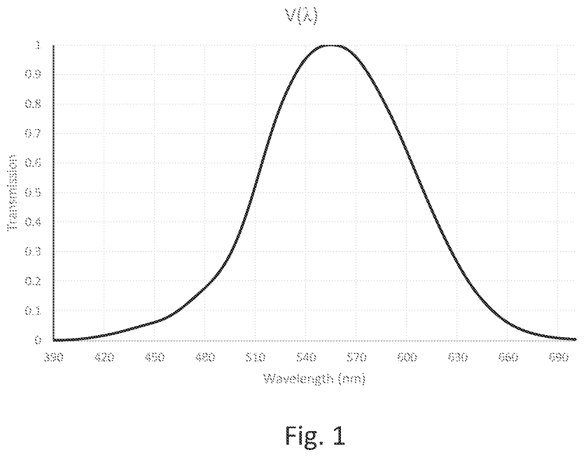

### DESCRIPTION OF PREFERRED EMBODIMENTS

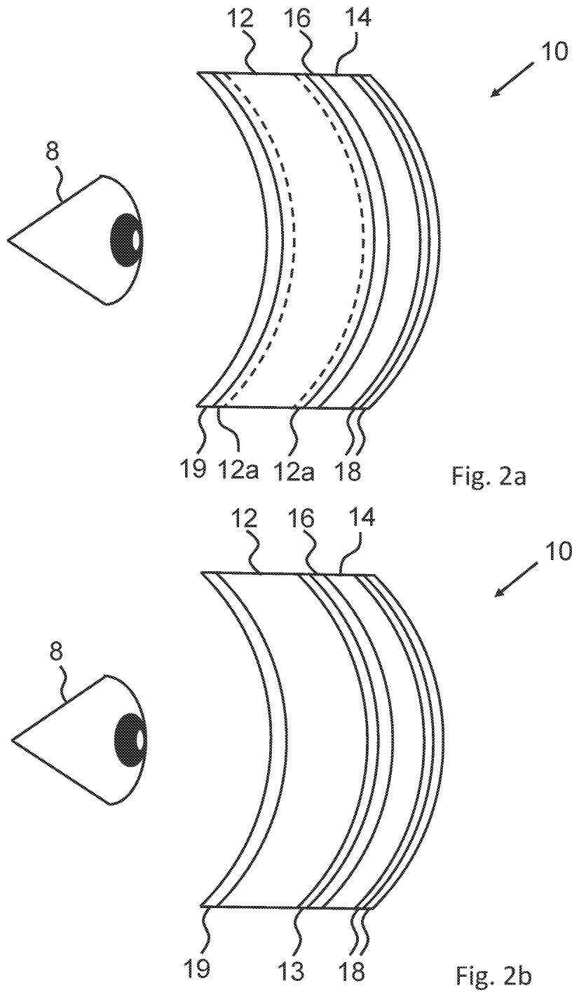

FIG. 2a shows a schematic view of the structure of an exemplary colour filter 10 according to the invention. The figure is not to scale, so the relative thickness of each layer and other dimensions of the colour filter 10 (height, curvature) have no relevance in the figure, it is merely illustrative.

The colour filter 10 is intended to modify human colour vision, which is ensured jointly by the dyed carrier layer 12 forming part of the colour filter 10 and the interference layer 14 provided as a thin layer system on one side of the dyed carrier layer 12, which may or may not be contiguous with the dyed carrier layer 12. Furthermore, it is also possible to have other layers between the dyed carrier layer 12 and the interference layer 14, as will be discussed later. The dyed carrier layer 12 may be dioptric or non-dioptric. In the present example, the dyed carrier layer 12 is dyed using a thermodiffusion process, so that the dye has diffused into both surface layers of the carrier layer 12 on both sides to a depth of a few micrometres. In FIG. 2a, the surface layers containing the dye are indicated by the reference number 12a. An embodiment is also conceivable wherein the material of the carrier layer 12 is dyed such that the dye is mixed with the material used to form the carrier layer 12 prior to the manufacture of the carrier layer 12, whereby the entire material of the carrier layer 12 is dyed. In this case the dyed carrier layer 12 is made of dyed material. The carrier layer 12 made of dyed material is preferably used to make a colour filter without refractive power or with low refractive power (preferably less than 1 dioptre), because if the carrier layer 12 made of dyed material is ground to a shape providing higher refractive power, the spectral transmission function of the carrier layer 12 made of dyed material having variable thickness will be different at the centre of the carrier layer 12 from that at the edge of the carrier layer 12.

Preferably, a lacquer layer 16 is provided between the carrier layer 12 and the interference layer 14 to smooth the surface under the interference layer 14 for a more adhesive application of the thin layer system.

In this embodiment, additional functional layers 18 are provided. Such a functional layer 18 may be, for example, a scratch-resistant layer, an anti-reflection layer, a vapor repellent layer, a fingerprint repellent layer, a dirt repellent layer, a UV filter layer, and the like.

In the present case, two functional layers 18 are shown on the side of the interference layer 14 opposite the carrier layer 12, but of course there may be more or fewer functional layers 18, and they may be located elsewhere in any conventional manner, for example on the other surface of the colour filter 10, or on both surfaces, or inside the colour filter 10 between two other layers.

In the present embodiment, an absorption layer 19 is formed on the inner side of the carrier layer 12 (i.e., the side intended to be the side facing an eye 8 of the user as schematically illustrated), which is itself a functional layer but with a separate reference number due to its special role. The absorption layer 19 can also be formed on the side of the carrier layer 12 facing the interference layer, in which case the lacquer layer 16 is preferably placed between the absorption layer 19 and the interference layer 14. Optionally, other functional layers 18 may be interposed between the dyed carrier layer 12 and the interference layer 14.

The absorption layer 19 has a substantially uniform absorption property either over the entire visible light range or only above at least 440 nm, so that it does not affect colour vision or only affects blue and violet colours. The absorption layer 19 prevents the disturbing reflection of light from the eye socket back towards the eye from the 14 interference layers by because the light reflected from the eye socket and then reflected back from the 14 interference layers have to pass through the 19 absorption layer twice, so that it is absorbed to a significantly greater extent than light coming from outside. This reduces the disturbing effect of the image reflected from the inner surface of the colour filter 10 (e.g. the reflection of the users eye), as the light coming through the outer surface of the colour filter 10 passes through the absorption layer 19 with a relatively higher intensity, thus suppressing the reflected image more. It is clear that the use of absorption layer 19 is not necessary, but is beneficial, as are the other functional layers 18.

The embodiment shown in FIG. 2b differs from the embodiment shown in FIG. 2a in that the carrier layer 12 is configured such that the colour vision modifying dye is applied as a separate dye layer 13 on one side of the carrier layer 12, in this case the side facing the interference layer 14. Of course, it is also conceivable that the dye layer 13 is applied to the other side, or both sides, of the carrier layer 12 to form the dyed carrier layer 12. The use of the lacquer layer 16 is also preferable in this case. Thus, if the dye is made to form an additional dye layer 13 and is applied on the side of the carrier layer 12 facing the interference layer 14, the lacquer layer 16 is preferably applied on the dye layer 13.

The embodiment shown in FIG. 2c differs from the embodiment shown in FIG. 2a in that the interference layer 14 is formed on a second carrier layer 12′, which is placed in front of the first carrier layer 12 thereby forming the colour filter 10. The second carrier layer 12′ is preferably substantially colourless and transparent in the visible light range, so that its effect on colour vision need not be considered separately in the design of the interference layer 14, as will be discussed in detail below.

In this embodiment, the lacquer layer 16 is preferably applied to the surface of the second carrier layer 12′ underneath the interference layer 14 and again serves to smooth the surface underneath the interference layer 14 for better adherence of the thin layer system.

Functional layers 18 can also be created on the second carrier layer 12′, just like on the first carrier layer 12. In the present embodiment, one functional layer 18 is provided on the surface of the first carrier layer 12 more remote from the eye and two functional layers 18 are provided on the outer surface of the interference layer 14 on the side of the second carrier layer 12′ more remote from the eye, but of course more or fewer functional layers 18 may be provided at these locations or elsewhere on the carrier layers 12, 12′.

According to this embodiment, the absorption layer 19 is arranged on the side of the first carrier layer 12 closer to the eye 8, but may be positioned anywhere else, provided that it is positioned between the interference layer 14 and the eye 8 when the colour filter 10 is worn as intended. For example, the absorption layer 19 may be formed on the side of the second carrier layer 12′ opposite the interference layer 14.

Preferably, the first carrier layer 12 forms the lens of a spectacles, while the second carrier layer 12′ provided with the interference layer 14 is designed as a clip-on lens for the spectacles. By clip-on lens is meant a lens that is equipped with any known attachment system for attachment to the spectacles, such as a fastening buckle, a hook or a magnetic fastening system. The advantage of using a clip-on lens is that the spectacles comprising the dyed carrier layer 12 can be used on their own, even by people with normal colour vision, for dioptric correction, blue light and/or UV filtering, colour brightening and/or colour modification, while the clip-on lens can be used for colour vision correction.

According to another preferred embodiment, the dyed carrier layer 12 (e.g., FIGS. 2a and 2b) provided with the interference layer 14 is configured as a clip-on lens so that it can be simply attached to conventional spectacles, such as dioptre glasses, in order to ameliorate colour vision deficiency.

FIG. 2d is a clip-on lens system corresponding to the embodiment shown in FIG. 2b. In this case, the interference layer 14 is formed on the second carrier layer 12′, while the first carrier layer 12 is provided with the dye layer 13.

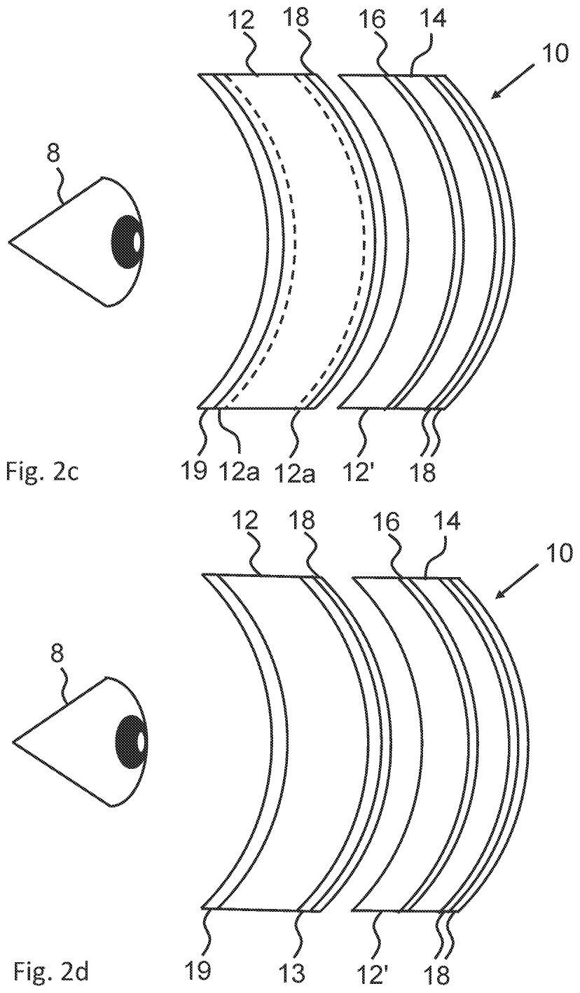

FIG. 3a is a plot showing the spectral transmission function (T(λ)) of a first exemplary colour filter 10 according to the invention, the spectral transmission function (T_{sd}(λ)) of a pre-dyed carrier layer 12 used in the colour filter 10, and the V-lambda function (V(λ)) normalized to 1. The exemplary colour filter 10 in FIG. 3a is used to correct for strong deuteranomaly.

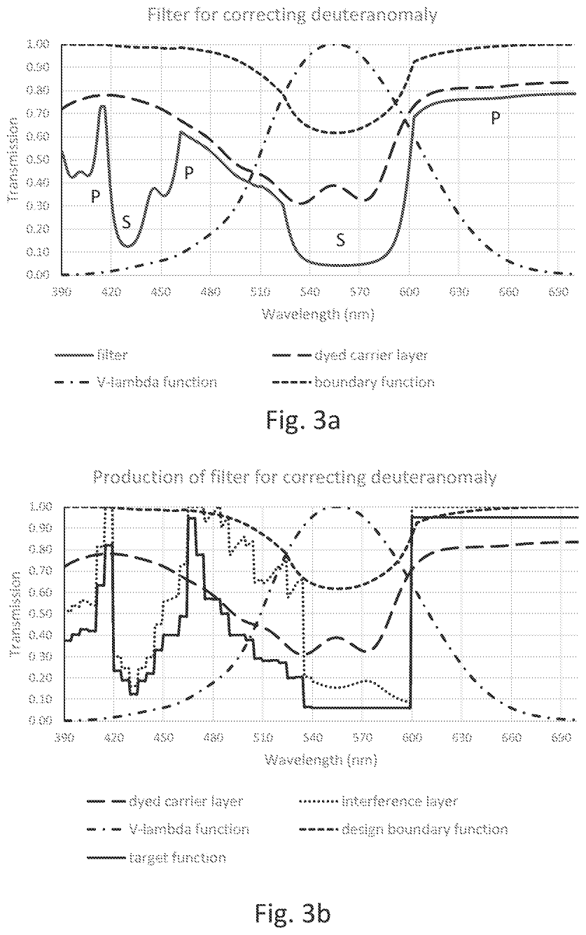

FIG. 4a is a plot showing the spectral transmission function (T(λ)) of a second exemplary colour filter 10 according to the invention, the spectral transmission function (T_{sd}(λ)) of a pre-dyed carrier layer 12 used in the colour filter 10, and the V-lambda function (V(λ)). The example colour filter in FIG. 4a is used to correct for moderate protanomaly.

The spectral transmission function T(λ) of the colour filter 10 according to the invention in the visible light range is such that the average transmission in a wavelength range of at least 20 nm width below 530 nm is at least twice the average transmission in a second wavelength range between 530 and 580 nm, and the average transmission in a wavelength range of least 20 nm width above 580 nm is at least twice the average transmission in the second wavelength range. It is noted that the boundaries of the at least 20 nm wide range below 530 nm and the at least 20 nm wide range above 580 nm are not necessarily 530 nm and 580 nm, respectively. The upper limit of one of the 20 nm or wider wavelength bands can be anywhere below 530 nm and the lower limit of the other 20 nm or wider wavelength band can be anywhere above 580 nm. In practice, this means that the spectral transmission function T(λ) of the colour filter 10 has a lower transmission somewhere between 530 nm and 580 nm, while there is at least one peak in the transmission below and above this wavelength range, where the colour filter 10 has a significantly higher transmission. On the one hand, this is a characteristic of colour filters that correct for colour vision deficiency, since the maximum positions of the sensitivity functions of the L-cones and M-cones receptors are shifted towards each other somewhere in the second wavelength range, and therefore such colour filters reduce transmission in this second range. On the other hand, the value of the V-lambda function is also most significant in this second wavelength range, so it is particularly important to achieve the reduction of transmission as much as possible with absorbing dyes within this wavelength range.

To this end, the colour filter 10 according to the invention is such that the following relation exists between the transmission function T_{sd}(λ) of the dyed carrier layer 12 and the transmission function T(λ) of the colour filter 10 within the second wavelength range:

T_{sd}(λ)<1−V(λ)·(1−T(λ))·n (1)

where n≥0.4, more preferably n≥0.5. The higher the value of n, the smaller the number on the right side of the inequality, consequently the smaller the transmission allowed for the carrier layer 12, whereby the greater the contribution of the carrier layer 12 to the total transmission reduction. By including V(λ) as a multiplier on the right-hand side, it is ensured that as the wavelength approaches the maximum of V(λ), the dyed carrier layer 12 is required to play a larger and larger role in the transmission reduction.

The expression on the right-hand side of the inequality is called the boundary function, and the boundary function associated with the multiplying factor n is denoted by hₙ(λ):

hₙ(λ)=1−V(λ)·(1−T(λ))·n (2)

Thus, the relation (1) can be written in the following form:

T_{sd}(λ)<hₙ(λ) (3).

It should be noted that the transmission functions of the colour filter components are multiplicative. This means that the transmission function T(λ) of the colour filter 10 can be obtained as the product of the transmission function T_{sd}(λ) of the dyed carrier layer 12 and the transmission function Tᵢ(λ) of the interference layer 14.

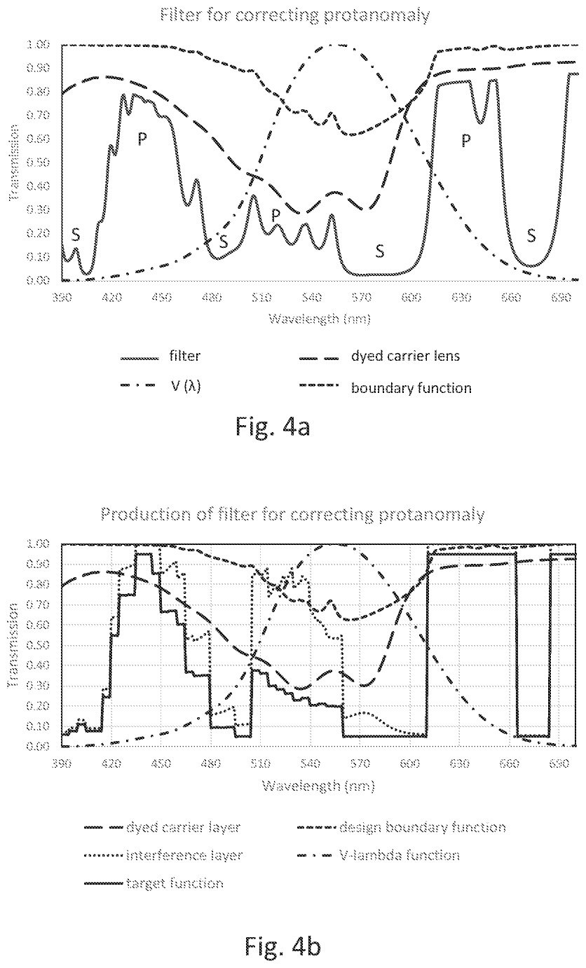

Similarly, the transmission function of the dyed carrier layer 12 can be written as the product of the transmission function of the un-dyed carrier layer 12 and the applied dye, but it is more appropriate to talk about the transmission of the dyed carrier layer 12, since the reduction in transmission due to the dye depends on the amount of the dye used. The transmission characteristics of the dye do not change, i.e. at which wavelengths it absorbs light more and at which wavelengths it transmits light more, but the rate of absorption, and hence the reduction in transmission, depends on the amount of absorbent dye molecules that are in the path of the light. FIG. 5 shows the transmission curves of an initially colourless transparent carrier layer 12 used in the colour filter 10 illustrated in FIGS. 3a and 4a which carrier layer 12 was dyed with the same dye but over different periods of dyeing time. It can be clearly seen that the characteristics do not change, but the transmission curves for longer dyeing times are deeper, with a larger decrease in transmission. In FIG. 5, the dyeing time which resulted in the curve with the highest spectral transmission was 5 min, while the lowest spectral transmission was obtained with a dyeing time of 60 min.

In FIGS. 3a and 4a, we have plotted the boundary function hₙ(λ) for n=0.4. As can be seen, in both examples, the transmission function T_{sd}(λ) of the dyed carrier layer 12 satisfies relation (3) not only within the second wavelength range, but also within the entire visible range. This also indicates that relations (1) and (3) can be valid over a wider wavelength range as well, which further contributes to the positive effect recognised by the inventors, i.e. the elimination of disturbing reflections. Preferably, relation (1) exists between at least 500 and 600 nm, more preferably between at least 480 and 650 nm.

If a colourless, transparent, lens is used as the carrier layer 12, i.e. a lens that is essentially fully transmissive (Ts(λ)≈1) over the entire visible light range, then the spectral transmission function T_{sd}(λ) of the dyed carrier layer 12 is essentially the same as the spectral transmission function T_{d}(λ) of the dye used (or, in the case of multiple dyes, their combined transmission function T_{d}(λ)), which of course depends on the concentration of the dye(s) as explained above. If the carrier layer 12 itself reduces the transmission, i.e. it has a spectral transmission function Tₛ(λ) which is not constant 1, then the spectral transmission function T_{sd}(λ) of the dyed carrier layer 12 is determined by the product of the transmission function Tₛ(λ) of the un-dyed carrier layer 12 and the transmission function T_{d}(λ) of the dye(s). If a separate second carrier layer 12′ is used, then the spectral transmission function T_{sd}(λ) of the dyed carrier layer 12 is understood to include the transmission function of the second carrier layer 12′, i.e. in this case the spectral transmission function T_{sd}(λ) of the dyed carrier layer 12 is the product of the transmission function of the un-dyed carrier layer 12, the transmission function of the second carrier layer 12′ and the transmission function of the dye(s) used. However, it is preferable to use a colourless, transparent, lens as the second carrier layer 12′ as well, i.e. a lens which is substantially fully transmissive over the entire visible light range, so that the transmission function of the second carrier layer 12′ is also substantially constant 1 and need not be taken into account.

The purpose of using the dyed carrier layer 12 is to obtain the desired transmission reduction in the vicinity of the maximum of the V-lambda curve at least partly by absorption as opposed to reflection provided by the interference layer 14. Therefore, the dyed carrier layer 12 contains at least one dye, which has an absorption peak (and a transmission minimum) between 530 and 580 nm. In order for the dyed carrier lens 12 to fulfil its purpose the transmission minimum of dyed carrier lens 12 should be substantially smaller than the transmission maximum thereof. In other words, a dyed carrier lens 12 of substantially constant transmission cannot be used. Preferably, the maximum transmission of the dyed carrier lens 12 below 500 nm and above 600 nm, but within the visible spectrum, is at least 1.5 times the transmission minimum between 530 and 580 nm, more preferably it is at least twice the transmission minimum between 530 and 580 nm.

Preferably, the carrier layer is pre-dyed with at least one broad absorption band dye having an absorption band in the visible spectrum with an FWHM of more than 40 nm around its absorption peak, but preferably more than 50 nm, more preferably more than 60 nm but preferably less than 150 nm. In FIG. 3a, an initially colourless transparent carrier layer 12 pre-dyed with such a broad absorption band dye forms the basis of the colour filter 10. The transmission function T_{sd}(λ) in FIG. 3a is therefore essentially the same as the transmission function T_{d}(λ) of the dye. The transmission function T_{sd}(λ) shown in FIGS. 3a and 4a corresponds to the transmission function of an exemplary dye. This dye has proved particularly useful for the production of colour filters 10 for correcting colour vision deficiencies. It was found that for both the deuteranomaly (FIG. 3a) and protanomaly (FIG. 4a) correcting colour filters 10 the location of the low-transmittance region of the dye within the visible light range is well-suited, so that it can significantly decrease reflection compared to colour filters in which the transmittance is reduced by using an interference layer alone.

An embodiment in which the carrier layer is dyed with at least two dyes is also conceivable. Preferably, at least one of these dyes also has a broad absorption band. It may be the case that the desired transmission curve has a narrow stopband at the location where the absorption minimum of a narrow absorption band dye is located, in which case it is desirable to use such a narrow absorption band dye in addition to the broad absorption band dye to create the narrow stopband. In the dyeing process, the different dyes may be mixed in advance or applied sequentially on the carrier layer 12.

In the example shown in FIGS. 3a and 4a, the shape of the spectral transmission function T(λ) of the filter 10 is such that the transmission is higher within some wavelength ranges and lower in the wavelength ranges that separate them. Wavelength ranges with higher transmittance are usually referred to as passbands, denoted in the figures by the letter P, while wavelength ranges with lower transmittance separating them are usually referred to as stopbands, denoted in the figures by the letter S. Clearly, the P passbands do not necessarily allow maximum transmission (which would correspond to a transmission value of 1), just as the S stopbands do not need to be fully blocking (which would correspond to a transmission value of 0).

The boundaries of the passbands are conventionally defined by the FWHM. The lower and upper limiting wavelengths defining the FWHM are the two wavelengths at which the transmission value reaches half of the maximum transmission value of the passband. The FWHM is therefore the difference between the upper and lower limiting wavelengths. The centre wavelength is the lower limit wavelength plus half the FWHM. In the context of the present invention, the passband is considered to be located between the two limiting wavelengths, i.e. the boundary of the passband is where the transmission is halved relative to the maximum within the passband.

Since the passbands are bounded by the lower and upper limit wavelengths that define the FWHM, it is reasonable to assume that the adjacent stopband starts from here. For this reason, on the one hand, the transmission may differ significantly at one border of the stopband and at the other, and on the other hand, the transmission may still be quite large at the borders. Note that a passband sandwiched between two stopbands will always “stand out” from the adjacent stopbands, because the band boundary is defined through the FWHM, whereby the transmission maximum of the passband is necessarily at least twice as large as the transmission minimum of the adjacent stopband.

It is clear that the condition that the average transmission in the first wavelength range below 530 nm, which is at least 20 nm wide, and in the third wavelength range above 580 nm, which is at least 20 nm wide, is at least twice as large as the average transmission in the second wavelength range between 530 and 580 nm, may also be formulated such that the spectral transmission function of the colour filter 10 comprises at least two passbands P and a stopband S separating them, said stopband S overlapping at least partially the second wavelength range. The colour filter 10 according to the invention is particularly useful in cases where the average transmission of the stopband within the overlapping range is less than 20% over at least 20 nm, preferably less than 10%, as illustrated by the embodiment of FIG. 3a. For such a colour filter 10, a very significant reduction in transmission should be achieved in the wavelength range where the value of the V(λ) function is also largest. In this case, the hybrid technology according to the invention, i.e. the combined use of the absorbent dye and the interference layer 14, results in a particularly large reflection reduction improvement.

For a multiband T(λ) transmission function, the dyed carrier layer 12 and the interference layer 14 together provide the at least two passbands P and the stopband S in between.

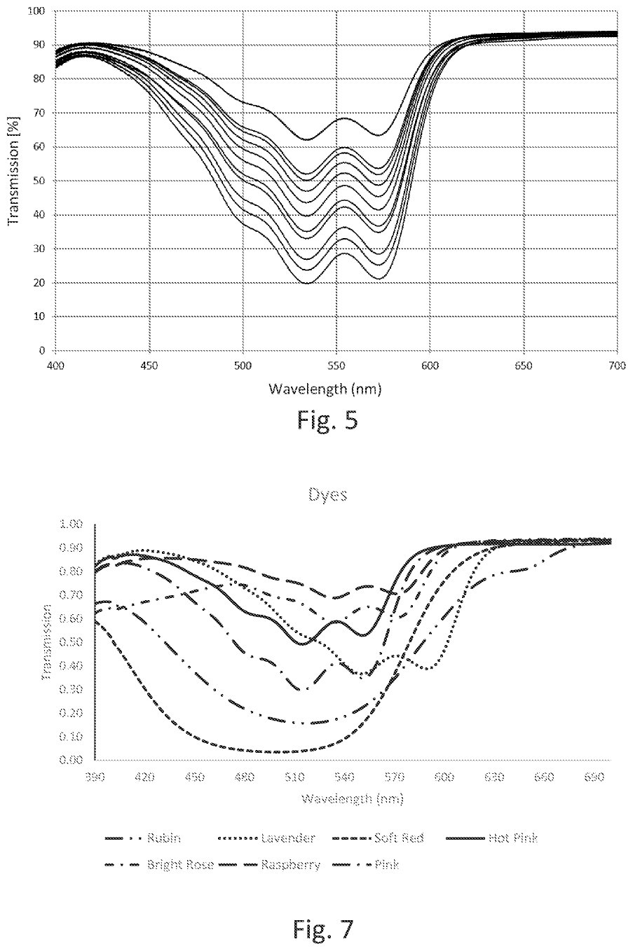

In the following, the method of designing the colour filter 10 with spectral transmission function T(λ) as shown in FIGS. 3a and 4a is described with reference to the flow diagram of FIG. 6 and the graphs in FIGS. 3b and 4b. FIG. 3b relates to the production of the exemplary colour filter 10 for deuteranomaly correction illustrated in FIG. 3a, while FIG. 4b relates to the production of exemplary colour filter 10 for protanomaly correction illustrated in FIG. 4a.

Producing a colour filter to modify the colour vision starts from a spectral transmission target function provided in step S10. This can be a design curve defined on the basis of a theoretical model, for example as described in patent application PCT/HU2020/050043. Another possibility is to start from an existing (e.g. a known and well performing) colour filter wherein an interference layer serves to modify the colour vision, however, in order to reduce reflection, it is desired to partially create the spectral transmission function of the existing colour filter with an absorption dye. In the latter case, the spectral transmission function of the existing colour filter is taken as the target function.

From the target function, a design boundary function is determined which is similar to the boundary function mentioned above:

hₙ*(λ)=1−V(λ)·(1−T₀(λ))·n (4)
where
T₀(λ): is the target function,
V(λ): the V-lambda curve of the human eye,
n≥0.4.

In step S14 an un-dyed carrier layer 12 is selected and at least one dye such that their combined transmission function T_{sd}(λ) (when the carrier layer 12 is dyed with the at least one dye) is smaller than the design boundary function:

T_{sd}(λ)<hₙ*(λ) (5)

Preferably, an initially transparent, colourless carrier layer 12 is selected so that the characteristic of the transmission function T_{sd}(λ) is determined by the dye or dyes to be used. In this case, the at least one dye must be selected so that its characteristics fit the shape of the design boundary function hₙ*(λ). By adjusting the concentration of the at least one dye, having a given characteristic, the absolute value of the transmission can be set (i.e. how much the transmission should be reduced), as described in connection with FIG. 5. There are a number of commercially available dyes, the transmission characteristics of which can be obtained from the manufacturer or can be easily measured using a spectrophotometer (e.g., a colourless transparent carrier is dyed with that dye at the concentration recommended by the manufacturer).

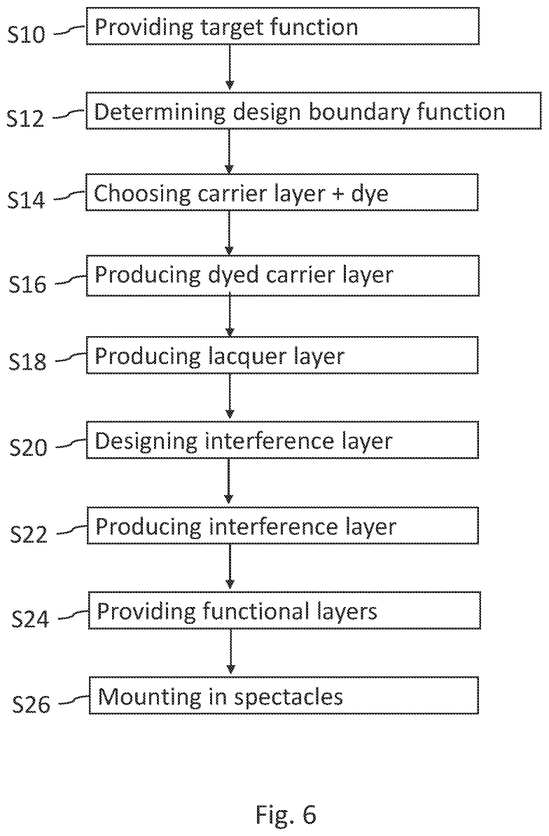

Typically, a dye kit with multiple dyes is available (this may include commercially available dyes for dyeing carrier layers, a mixture of several dyes mixed from elemental dyes, and dyes obtained by other means). From the transmission characteristics of the available dyes measured or selected from the manufacturer's catalog, it is possible to select the one that best fits the shape of the target function and to determine the concentration at which, when applied to the carrier layer 12, the resulting transmission remains below the design boundary function hₙ*(λ) at least within the second wavelength range. In our experience it is possible to find such a dye even among commercially available dyes, in case of a target function of a colour filter for colour vision deficiency correction which has a stopband S at least partially overlapping the second wavelength range and at least one passband P to the right and at least one passband P to left of it. Several exemplary commercially available absorption dyes are shown in FIG. 7, which, based on their characteristics, may be suitable for the manufacture of colour filters 10 having a stopband S at least partially overlapping the second wavelength band and at least one passband P to the right and to the left of the second wavelength band. Preferably, both in the choice of dye and in the choice of concentration, care is taken that the absorption caused by the dye does not bring the transmission significantly below the target function. For this purpose, the carrier layer and the at least one dye are chosen such that the transmission function T_{sd}(λ) of the dyed carrier layer satisfies the following relation in the visible light wavelength range

T₀(λ)*m≤T_{sd}(λ) (6)

where

$$m = \{ \begin{matrix}0.8 if λ < 530 nm \\ 0.95 if 530 nm \leq λ \leq 580 nm \\ 0.8 if 580 nm < λ\end{matrix}$$

It is noted that, although the choice of the at least one dye is obviously simpler if a transparent, colourless carrier layer 12 is to be used, which does not need to be taken into account when choosing the desired transmission characteristics, the complexity of dye selection for a carrier layer 12 with a different transmission does not exceed the level of routine work. It is known that the transmission of the dye and the un-dyed carrier layer 12 are multiplied in the dyed carrier layer 12. Note also that the task is also greatly simplified in case of a non-transparent carrier layer 12 with approximately constant transmission (colourless), since such carrier layer 12 also has no significant effect on the transmission characteristics required by the shape of the target function (i.e. where absorption should be higher and where it should be lower). In this case, it is sufficient to look at the transmission characteristics of the dye.

After selecting the carrier layer 12 and the at least one dye, the dye is used to produce the dyed carrier layer 12 in step S16. In a preferred embodiment, the carrier layer is dyed using thermodiffusion technology with the at least one dye.

The thermodiffusion dyeing process is well known to the skilled person, so it will only be briefly described here. The dye is diluted in water, preferably at the concentration recommended by the dye manufacturer. The resulting suspension is heated in a heatable bath to a high temperature (typically above 90°), and the un dyed carrier layer 12 is then immersed in the hot dye suspension. The high temperature causes the dye particles to diffuse from the suspension into the material of the carrier layer 12, typically to a depth of 1-10 μm. After the desired dye concentration is reached, the carrier layer 12 is removed from the bath. The concentration of the dye generated in the carrier layer 12 depends on the concentration of the dye in the suspension, as well as the temperature used and the dyeing time, as is well known to the person skilled in the art. After dyeing, the dyed carrier layer 12 is washed and dried in the usual manner.

In another preferred embodiment, the dyed carrier layer 12 is produced by applying a layer of the at least one dye to one or both surfaces of the carrier layer.

In a further preferred embodiment, the dyed carrier layer 12 is produced by dyeing the material of the carrier layer 12 with the at least one dye, and then subsequently producing the carrier layer 12 from the dyed material. This dyeing method is preferably used only for non-refractive colour filters 10 or colour filters 10 with a dioptre of less than 1.

Preferably, in step S18, the dyed carrier layer 12 is coated on one or both sides with a thin lacquer layer 16. This can also be done in a known lacquering apparatus, either by dip-coating or spin-coating.

After lacquering, the dyed carrier layer 12 is dried in step S19, preferably at high temperatures, e.g. in a drying oven known per se. Due to the high temperature, the solvent present in the lacquer during application evaporates quickly and the lacquer hardens.

The interference layer 14 is then created on the dried lacquer layer 16 as an optical thin layer system. To do this, in step S20, an optical thin layer system is designed starting from the transmission function T_{sd}(λ) of the dyed carrier layer 12.

The optical thin layer system is designed so as to have a transmission function which, together with the transmission function T_{sd}(λ) of the dyed carrier layer 12 produces a good approximation of the target function. Several known software are available to produce the optical thin layer structure, such as optical thin layer design software called FilmStar, in which the T_{sd}(λ) transmission function of the dyed carrier layer 12 can be specified as the initial function and the T₀(λ) transmission function can be inputted as the target function to be achieved. FIGS. 3b and 4b show the target transmission function of the interference layer by dotted line. This target transmission function is obtained by dividing the T₀(λ) target function by the T_{sd}(λ) initial function. If the software which is used to create the thin layer system does not allow to determine an initial transmission function, then the target function can be modified by dividing it with the T_{sd}(λ) transmission function of the dyed carrier layer 12. The materials from which each thin layer can be formed are also specified in the optical thin layer design software. This usually involves the use of at least one material with a lower refractive index and at least one material with a higher refractive index.

As a result of the transmission reduction already ensured by the dyed carrier lens 12, the interference layer 14 may have higher transmission in the vicinity of the maximum of the V-lambda function, which is at approx. 555 nm. The interference layer 14 reduces transmission partly by way of reflection, which is particularly disturbing within a wavelength range of 30 nm centred on 555 nm, i.e. between 540 nm and 570 nm due to the high value of the photopic luminous efficiency function (V(λ)) of the human eye in this range. A typical colour filter designed for correcting colour vision deficiency may have a minimum transmission of approx. 5-6% within the wavelength range of 540 nm to 570 nm as can be seen in FIGS. 3a, 3b, 4a, 4b.

Without the dyed carrier layer 12 the interference layer 14 would also need to have a minimum transmission of 5-6% between 540 nm and 570 nm order to achieve the design transmission. However, this would result in very high reflection which is disturbing for the user as discussed in connection with the background art. According to the embodiment of FIG. 3b the dyed carrier layer 12 reduces the transmission to below 40% in the range of 540 nm to 570 nm, whereby the interference layer 14 may have a minimum transmission greater than 15% within this wavelength range as calculated from the target function and as shown by the dotted line. Similarly, according to the embodiment shown in FIG. 4b the dyed carrier layer 12 reduces the transmission to below 40% as compared to a perfectly transparent lens having 100% transmission, whereby the interference layer 14 may have a minimum transmission greater than 15% within this wavelength range as calculated from the target function and as shown by the dotted line. Depending on the transmission profile and the amount of the dye used in the dyed carrier layer 12, the minimum transmission of the interference layer 14 may be even greater in the wavelength range of 540 nm to 570 nm. According to other preferred embodiments the minimum transmission of the interference layer 14 in the wavelength range of 540 nm to 570 nm is preferably above 20%, more preferably above 40%, even more preferably above 60%. For example, the dye known as Epolight™ 5391 Visible Light Dye supplied by Epolin, LLC., Newark, N.J. can be used.

In step S22, the interference layer 14 is created on the carrier layer 12 by creating the designed optical thin layer system. For example, the interference layer 14 can be formed by vacuum evaporation, such that the dyed carrier layer 12 is placed in a vacuum chamber and at least two kinds of materials are alternatingly evaporated onto the surface of the lens using electron beams. The thin layers created by the vapour deposition process form the interference layer 14.

If the interference layer 14 is to be placed on a separate clip-on lens, the interference layer 14 is created on the second carrier layer 12′ as described above.

Preferably, the optional functional layers 18 (e.g. scratch resistant layer, anti-reflection layer, anti-fog layer, fingerprint repellent layer, dirt repellent layer, UV filter layer, etc.) are then formed in step S24 in a manner known per se.

Preferably, the absorption layer 19 is formed as a functional layer 18 on the side of the carrier layer 12 opposite the interference layer 14. In a preferred embodiment, the absorption layer 19 is formed by applying a dye that is substantially uniformly absorbing in the visible light range, thus forming an absorption dye layer on the side of the carrier layer 12 opposite the interference layer 14. In this case, the dye of the absorption layer 19 can be ignored in the design of the interference layer 14, since it does not change the transmission characteristics, but instead reduces the transmission uniformly over the entire visible light range. However, if an absorption dye is used in the absorption layer 19 that has a non-constant transmission function, the effect of this is preferably taken into account in the design of the thin layer, for example by considering it as part of the dyed carrier layer 12.

In another preferred embodiment, the absorption layer 19 is created by a vacuum vapor deposition technique, e.g., by vapor depositing chromium as the absorption layer 19. In this case, the chromium layer is preferably formed on the side of the dyed carrier layer 12 opposite the interference layer 14.

The design of the absorption layer 19 may precede the creation of the interference layer 14.

Optionally, if a second carrier layer 12′ is used, one or more functional layers 18, including the absorption layer 19, may be formed on the second carrier layer 12′ on the side of the second carrier layer 12′ opposite the interference layer 14 in step S24 as described above.

The colour filter 10 according to the present invention can be mounted in a spectacle frame as a spectacle lens in step S26, thus creating a colour filtering spectacle. The insertion into the spectacle frame can be done in a way known per se: the circumference of the finished spectacle lenses is shaped to fit exactly into the spectacle frame, and then the spectacle lens is inserted into the frame. After this it is preferably cleaned and packaged for sale.

If the interference layer 14 is to be used as dip-on lens, only the first carrier layer 12 is mounted in the frame and the second carrier layer 12′ is fitted with a suitable dip-on attachment system to allow it to be attached to the spectacles at a later stage.

Another option is that there is no second carrier layer 12′, but the interference layer 14 and optional other layers are formed on the dyed carrier layer 12, and the clip-on mounting system is placed on this carrier layer 12, so that the entire colour filter 10 is formed as dip-on lens. The advantage of this is that a person with colour vision deficiency can simply fit the dip-on colour filter 10 onto their existing conventional spectacles, such as dioptric spectacles.

Various modifications to the above disclosed embodiments will be apparent to a person skilled in the art without departing from the scope of protection determined by the appended claims.

1. A colour filter for modifying human colour vision, having a spectral transmission function in the visible light range wherein the average transmission in a first wavelength range of at least 20 nm width below 530 nm is at least twice the average transmission in a second wavelength range between 530 and 580 nm, and the average transmission in a third wavelength range of least 20 nm width above 580 nm is at least twice the average transmission in the second wavelength range, characterized in that it comprises an interference layer and a carrier layer dyed with at least one dye, the transmission function of the dyed carrier layer and the transmission function of the colour filter have the following relationship within the second wavelength range:
T_{sd}(λ)<1−V(λ)·(1−T(λ))·n (1)
wherein
T(λ): is the transmission function of the colour filter,
T_{sd}(λ): is the transmission function of the dyed caner layer,
V(λ): is the CIE photopic luminous efficiency function,
n≥0.4
and a minimum transmission of the interference layer between 540 nm and 570 nm is at least 15%.

2. A colour filter according to claim 1, characterized in that n≥0.5.

3. A colour filter according to claim 1, characterized in that the minimum transmission of the interference layer between 530 nm to 580 nm is above 20%, preferably above 40%, more preferably above 60%.

4. A colour filter according to claim 1, characterized in that the dyed carrier layer has refractive power.

5. A colour filter according to claim 1, characterized in that the carrier layer is dyed with at least one broad absorption band dye having a full-width at half maximum greater than 40 nm and smaller than 150 nm around its absorption peak.

6. A colour filter according to claim 5, characterized in that the carrier layer is dyed with at least two dyes, at least one of which is the at least one broad absorption band dye.

7. A colour filter according to claim 1, characterized in that the dyed carrier layer comprises the at least one dye in its material.

8. A colour filter according to claim 1, characterized in that the at least one dye is applied as a dye layer on at least one surface of the carrier layer.

9. A colour filter according to claim 1, characterized in that the spectral transmission function of the colour filter comprises at least two passbands and a stopband separating them, the stopband at least partially overlapping the second wavelength range in an overlapping range, and the dyed carrier layer and the interference layer jointly provide the at least two passbands and the stopband.

10. A colour filter according to claim 9, characterized in that the average transmission of the stopband (S) within the overlapping range is less than 20% over at least 20 nm, preferably less than 10%.

11. A colour filter according to claim 9, characterized in that the dyed carrier layer and the interference layer jointly provide at least three passbands and two stopbands separating the neighbouring passbands.

12. A colour filter according to claim 1, characterized in that the dyed carrier layer is provided with an absorption layer, which absorption layer is substantially uniformly absorbing in the visible light range above at least 440 nm.

13. A colour filter according to claim 1, characterized in that it comprises at least one functional layer selected from the group consisting of scratch resistant layer, anti-reflection layer, vapour repellent layer, fingerprint repellent layer, dirt repellent layer and UV filter layer.

14. A colour filter according to claim 1, characterized in that the interference layer is provided on the dyed carrier layer, preferably on a lacquer layer applied to a surface of the dyed carrier layer.

15. A colour filter according to claim 1, characterized in that the interference layer is provided on a second carrier layer, preferably on a lacquer layer applied to a surface of the second carrier layer, said second carrier layer being separate from the dyed carrier layer.

16. Spectacles for modifying human colour vision, characterized in that they comprise a colour filter according to claim 1.

17. Spectacles according to claim 16, characterized in that the dyed carrier layer is ground as a spectacle lens and the interference layer is provided on the dyed carrier layer, preferably on a lacquer layer applied to a surface of the dyed carrier layer.

18. Spectacles according to claim 16, characterized in that the dyed carrier layer is ground as a spectacle lens and the interference layer is formed on a transparent second carrier layer, preferably on a lacquer layer applied to a surface of the second carrier layer, the second carrier layer being provided as a clip-on lens attachable to the spectacles.

19. Method of producing a colour filter for modifying human colour vision, providing a spectral transmission target function for which the average transmission in the visible light range in a first wavelength range of at least 20 nm width below 530 nm is at least twice the average transmission in a second wavelength range between 530 and 580 nm, and the average transmission in a third wavelength range of at least 20 nm width above 580 nm is at least twice the average transmission in the second wavelength range, characterized by providing a carrier layer, dying the carrier layer with at least one dye to produce a dyed carrier layer having a transmission function wherein an average transmission between 540 nm and 570 nm is less than 40% and having, the transmission function of the dyed carrier layer and the target function having the following relation at least within the second wavelength range:
T_{sd}(λ)<1−V(λ)·(1−T₀(λ))·n
wherein
T₀(λ): is the target function,
T_{sd}(λ): is the transmission function of the dyed carrier layer,
V(λ): is the V-lambda curve of the human eye,
n≥0.4;
designing an optical thin layer system, the transmission function of which,
together with the transmission function of dyed carrier layer, substantially produces the target function, and
producing the designed optical thin layer system so as to create an interference layer on one of the dyed carrier layer and a second carrier layer, which second carrier layer is separate from the dyed carrier layer and the transmission of which is taken into account as part of the transmission function of the dyed carrier layer.

20. The method according to claim 19, characterized in that the transmission function of the dyed carrier layer substantially satisfies the following relation in the wavelength range of visible light
T₀(λ)*m≤T_{sd}(λ)
wherein
$$m = \{ \begin{matrix}0.8 if λ < 530 nm \\ 0.95 if 530 nm \leq λ \leq 580 nm \\ 0.8 if 580 nm < λ\end{matrix} .$$
